(19) United States
(12) Patent Application Publication
(10) Pub. No.: US 2021/0146177 A1
(43) Pub. Date: May 20, 2021

(54) FIRE EXTINGUISHER MOUNT

(71) Applicant: Rusoh, Inc., Eau Claire, WI (US)

(72) Inventors: Ryan J. Geissler, Eau Claire, WI (US); Justun Seymour, Eau Claire, WI (US); Seth Rooney, Chippewa Falls, WI (US)

(21) Appl. No.: 16/687,175

(22) Filed: Nov. 18, 2019

(51) Int. Cl. A62C 13/78

(52) U.S. Cl. CPC A62C 13/78

(57) ABSTRACT

A fire extinguisher device mount includes a support frame configured for coupling along a fire extinguisher device received in the device mount. The support frame includes at least one brace arm having a brace jaw and a device socket having an anchor cleat. A latch belt extends from the support frame and is configured to releasably surround the fire extinguisher device. A device brace is configured to secure the fire extinguisher device in a grasping configuration. The device brace in the grasping configuration includes the latch belt tightened around the fire extinguisher device. The at least one brace arm is deflected with engagement of the at least one brace jaw against the fire extinguisher device. The anchor cleat is engaged against the fire extinguisher device.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright Rusoh, Inc. of Eau Claire, Wis. All Rights Reserved.

### TECHNICAL FIELD

This document pertains generally, but not by way of limitation, to mom and care of fire suppression devices including fire extinguishers.

### BACKGROUND

Fire suppression devices, such as portable, manually operable, fire extinguishers are stored in a variety of environments and applications including marine applications, on board marine vessels, offshore platforms, docks in marinas or the like. In other examples, fire extinguishers are stored in dynamic environments including, but not limited to, vehicles such as construction equipment, planes, locomotives, marine vessels, firefighting and rescue vehicles or the like.

Fire extinguishers are mounted in these environments and vehicles at readily accessible locations that facilitate awareness of the locations. Fire extinguishers are mounted to walls or the like with mounting brackets. The brackets are, in some examples, metal and include one or more of a fork configured to grasp the head of the fire extinguisher or a plate to support the fire extinguisher from the bottom. In other examples, the brackets include hoops that extend around a fire extinguisher and buckle the extinguisher to the bracket and the associated wall.

### SUMMARY

The present inventors have recognized, among other things, that a problem to be solved can include maintaining a fire extinguisher and its associated mount in dynamic and corrosive environments. Fire extinguisher mounts are, in some examples, constructed with painted or powder coating steel; stainless steel, such as 300 series stainless steel; aluminum or the like. These materials are subject to corrosion, wear and eventual failure. Even passivated stainless steels (e.g., 300 series or the like) are subject to corrosion in harsh environments including salt water, chemical work areas or the life. Further, damage in dynamic environments caused by collisions, such as errant striking with tools, contact with equipment or personnel; and motion, such as vehicle operation, wave based motion, rugged equipment operation or the like crack or wear anti-corrosive coatings and accordingly accelerate corrosion. In some examples, damage and corrosion cause failure of the mount and corresponding damage to the fire extinguisher, potential injury or the like. Repair may be difficult or impossible if parts are not readily available. Replacement of the mount may require replacement of the fire extinguisher that fits with the replacement mount.

The present subject matter provides a solution to these problems with a fire extinguisher mount (e.g., a device mount) that is corrosion resistant and at the same secures a plurality of fire extinguishers having different profiles. The device mount includes a support frame including a device brace. The support frame includes a polymer construction configured to securely couple a fire extinguisher to one or more features including, but not limited to, walls, surfaces or the like. The device brace of the support frame includes at least one brace arm and an anchor cleat fire coupling with a portion of a fire extinguisher, such as a bottom flange of the extinguisher. In an example, the bottom flange is engaged with the anchor cleat or received between the anchor cleat and an opposed anchor wall.

The device mount includes a latch belt constructed with a polymer and latch configured for closing the latch belt and tightening the belt around the fire extinguisher, for instance with an over-center type latch. The latch belt cooperates with the device brace to provide secure multi-point support and retention between the device mount and the fire extinguisher. For example, tightening of the latch belt drives the fire extinguisher into engagement with the at least one brace arm of the device mount. Optionally, the device mount includes multiple brace arms. The at least one brace arm includes a polymer construction and is deflectable (e.g., elastically deformable) when loaded through force applied by the latch and latch belt. The latch belt drives the fire extinguisher into the at least one brace arm and the brace arm deflects along the container profile of the fire extinguisher. For instance, the brace arm and an associated brace jaw deflect and conform to the container profile of the fire extinguisher, thereby grasping the fire extinguisher and securing the extinguisher to the device mount. In one example, the deflected brace arm assumes a conforming configuration that corresponds to the proximate portion of the container profile.

The polymer construction of the device mount including the support frame and the latch belt enhances corrosion resistance of the device mount, and accordingly ensures reliable mounting of a fire extinguisher with the device mount. Additionally, tightening of the latch belt around the fire extinguisher drives engagement and deformation of the device mount relative to the fire extinguisher. Deflected brace arms conform to the container profile and thereby securely grasp the fire extinguisher. Additionally, multiple points of engagement are provided between the at least one brace arm and the anchor cleat to robustly couple the fire extinguisher to the device mount.

In still other examples, the device mount reclines the mounted fire extinguisher. For instance the support frame and the device socket of the device mount are inclined and thereby tip or lean the fire extinguisher into the device mount. Even when the latch belt is loose or decoupled, for instance during removal from the device mount, the reclined grade of the device mount minimizes potential falling of the fire extinguisher away from the device mount. Instead, the reclined grade tips the fire extinguisher back into the device mount and thereby passively holds the fire extinguisher in the mount until manually removed by an operator.

Optionally, the device mount includes a rotatable service carriage coupled with a service base. Some example fire extinguishers including stirring or fluffing operators for servicing of the fire extinguishing agent of extinguishers, for instance along a bottom surface. The rotatable service carriage couples with the fire extinguisher, and rotation of the rotatable service carriage correspondingly rotates the fire extinguisher from a stowed orientation to a service orientation. In the service orientation the stirring operator is readily accessed and turned. After servicing the fire extinguisher the service carriage is released (e.g., with a carriage lock) and the carriage s returned to the stowed orientation.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a perspective view of one example of a mounted fire extinguisher assembly.

FIG. 2A is a perspective view one example of a fire extinguisher device mount.

FIG. 2B is another perspective view of the fire extinguisher device mount of FIG. 2A.

FIG. 3A is a detailed perspective view of a portion of t extinguisher device mount of FIG. 2A.

FIG. 3B is an exploded view of one example of a latch and latch belt.

FIG. 4 is a perspective view the fire extinguisher device mount of FIG. 2A with a fire extinguisher nozzle in one example of a nozzle socket.

FIG. 5 is a side view of the mounted fire extinguisher assembly of FIG. 1 having the fire extinguisher mounted at a reclined angle.

FIG. 6A is a top view of one example of a device brace including at least one brace arm and example different fire extinguisher profiles.

FIG. 6B is another top view of the device brace of FIG. 6A in a grasping configuration with a fire extinguisher profile.

FIG. 7A is a perspective view of another example of a fire extinguisher device mount including a pivot joint.

FIG. 7B is a detailed perspective of one example of a pivot joint and a carriage lock.

FIG. 8 is a perspective view of the fire extinguisher device mount of FIG. 7A with a fire extinguisher in a service orientation.

FIG. 9 is a perspective view of another example of a fire extinguisher device mount including a configurable nozzle socket.

### DESCRIPTION

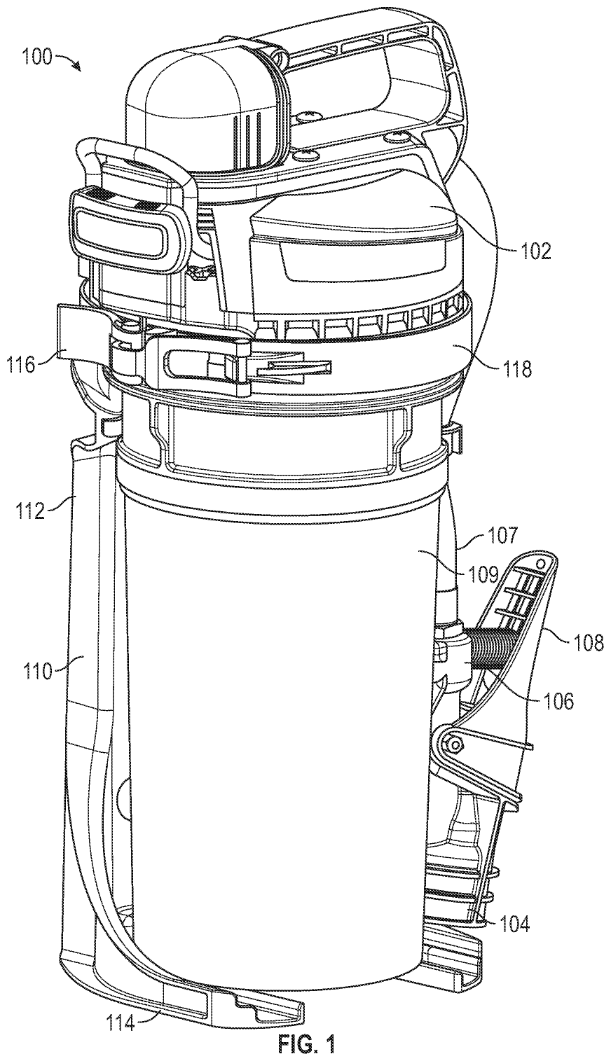

FIG. 1 is a perspective view of one example of a mounted fire extinguisher assembly 100. As shown, the assembly 100 includes a fire extinguisher 102 coupled with a device mount 110. The device mount 110 includes a support frame 112 and a device socket 114. As described herein, the support frame 112 and the device socket 114 of the device mount 110 are, in one example, constructed with a polymer including, but not limited to, nylon or the like. The device mount 110 includes a polymer construction and accordingly has enhanced corrosion resistance in contrast to metals, including stainless steel, powder coated steel, aluminum or the like, otherwise subject to oxidation, corrosion and eventual failure.

Referring again to FIG. 1, the fire extinguisher 102 is shown coupled with the device mount 110. In this example, the fire extinguisher 102 is received along the device socket 114 along a lower portion of the fire extinguisher 102 and the support frame 112. A latch belt 118 and a latch 116 extend around the fire extinguisher 102, for instance, around the agent container 109 and fasten the fire extinguisher 102 to the device mount 110. The fire extinguisher 102 further includes a discharge hose 107, a discharge valve 106 (e.g., provided at a distal end of discharge hose 107) and a valve operator 108. In the example shown in FIG. 1, the valve operator 108 is included at the nozzle 104 along with the discharge valve 106. Operation, such as depression, of the valve operator 108 opens the discharge valve 106 and thereby facilitates the delivery of a fire suppression agent from the nozzle 104.

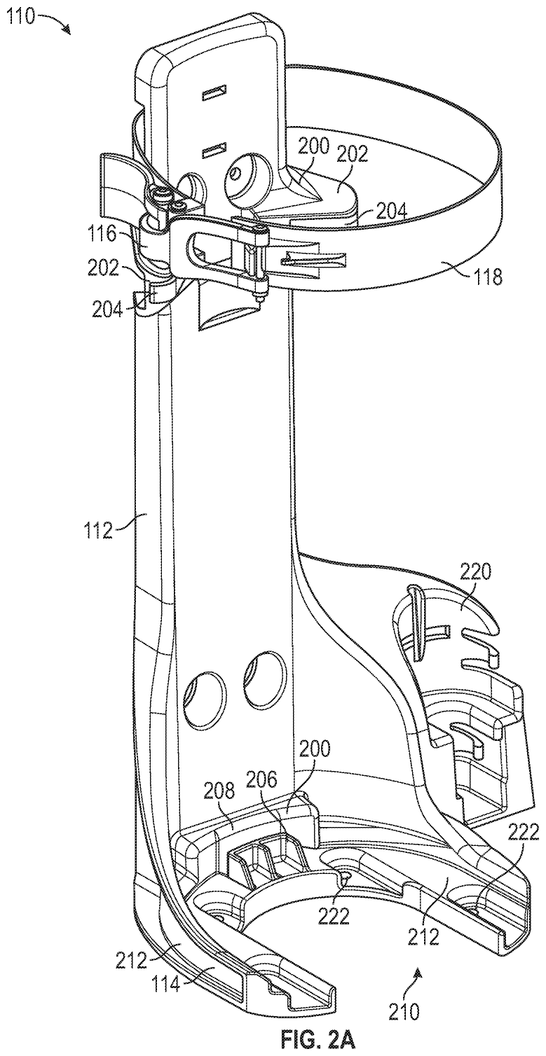

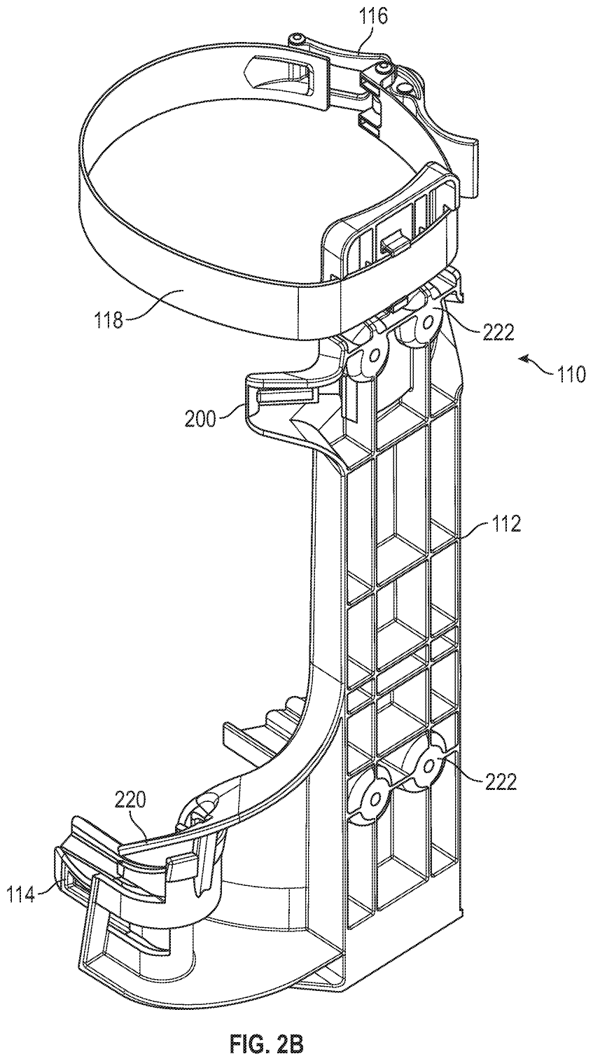

FIGS. 2A and 2B show opposed perspective views of the device mount 110 without the fire extinguisher 102 mounted therein. Referring first to FIG. 2A, the device mount 110, as previously described, includes a support frame 112 extending in a generally vertically fashion relative to a device socket 114. As further shown in FIG. 2A, in one example, a socket access opening 210 is provided, in one example, along the device socket 114. The socket access opening 210 facilitates access to one or more agitation operators or other features associated with the fire extinguisher 102 to facilitate servicing of the fire extinguisher while retained within the device mount 110 and minimizing servicing of the extinguisher decoupled from the mount 110.

As further shown in FIG. 2A, the latch belt 118 extends from the support frame 112 and extends around a portion of the device mount 110 configured for reception of the fire extinguisher 102 therein. The latch belt 118 is, in one example, constructed with a polymer material, for instance, nylon or the like. The latch 116, shown in FIG. 2A, couples ends of the latch belt 118 together. In one example, the latch 116 includes an over-center type latch configured to deform one or more components of the latch (e.g., the latch belt 118 or the latch 116) or the like to facilitate tight coupling around the fire extinguisher 102 and, as further described herein, deflect one or more components of a device brace, such as the device brace 200. As described herein, the deflected device brace 200 grasps the fire extinguisher in a secure manner that minimizes relative movement and accordingly retains the fire extinguisher in a static orientation even in dynamic environments, such as marine environments, on vehicles or the like.

As further shown in FIG. 2A, the device mount 110, in this example, includes a nozzle socket 220 configured for reception of one or more components of the fire extinguisher 102 including, for instance, the nozzle 104. In another example, the nozzle socket 220 is configured to receive and hold one or more other components proximate to the nozzle 104 including, for instance, the valve operator 108, discharge valve 106 or a proximate portion of the discharge hose 107 as shown, for instance, in FIG. 1. The nozzle socket 220, in one example, holds these components of the fire extinguisher 102 in a fixed configuration to substantially prevent the movement of the discharge hose and the associated components such as the nozzle 104 that may, in a dynamic environment, collide with components of the device mount 110 or the remainder of the fire extinguisher 102 and cause damage. Instead, the nozzle 104 is retained in place and thereby prevented from moving relative to the remainder of the fire extinguisher 102 and the device mount 110.

Referring now to FIG. 2B, a rear portion of the device mount 110 is shown. In the example provided, the device mount 110 includes one or more mounting ports 222 provided along the support frame 112. In other examples, the mounting ports 222 are also included along other components of the device mount 110, for instance, along one or more socket legs 212 of the device socket 114, as shown in FIG. 2A. The mounting ports 222 facilitate the installation of the device mount 110 on surfaces including, but not limited to, walls, floors, tables, cabinets, bulkheads or the like. For instance, the mounting ports 222 associated with the device socket 114 facilitate the mounting of the device mount 110 on horizontal surfaces of vehicles, tables, floors or the like.

Referring again to FIGS. 2A and 2B, as shown, the device mount 110 includes a device brace 200 configured to securely and robustly hold the fire extinguisher 102 within the device mount 110. As will be described herein, the device brace 200 includes one or more deflectable components configured to grasp fire extinguishers having different extinguisher profiles installed in the device mount 110 and thereby securely hold a plurality of different fire extinguishers within the device mount 110. The device mount 110 flexibly grasps a plurality of different extinguishers while minimizing relative motion and ensuring secure fastening of each type of fire extinguisher to one or more surfaces such as walls, floors, vehicle components or the like.

Referring first to FIG. 2A, the device brace 200 is shown with one or more brace arms 202. In the example shown in FIG. 2A, two brace arms 202 extend from the remainder of the support frame 112 and are proximate, in this example, to the latch belt 118. For instance, as shown, the brace arms 202 are positioned below the latch belt 118. The brace arms 202 include brace jaws 204. In one example, the brace jaws 204 include inserts, fittings or the like provided to the brace arms 202 to facilitate secure grasping of the fire extinguisher 102 installed in the device mount 110. As will be described herein, the brace arms 202 are deflectable. For instance, the brace arms 202 are constructed with, but not limited to, a deformable polymer, such as an elastically deformable polymer that deforms (without plastic deformation) to conform the brace arms 202 to a corresponding container profile or extinguisher profile of the fire extinguisher 102.

The device brace 200, in this example, further includes an anchor cleat 206. In the example shown in FIG. 2A, the anchor cleat 206 is provided along the device socket 114. The anchor cleat 206 engages with a portion of the fire extinguisher 102, such as a base flange or the like, to secure another portion of the fire extinguisher 102 within the device socket 114. As further shown in FIG. 2A, an anchor will 208 forms an optional component of the device brace 200. In one example, the anchor wall 208 and the anchor cleat 206 extending along a groove and one or more components of the fire extinguisher 102, such as the previously described base flange, are received between the anchor cleat 206 and the anchor wall 208 to securely hold the fire extinguisher 102 within the device socket 114.

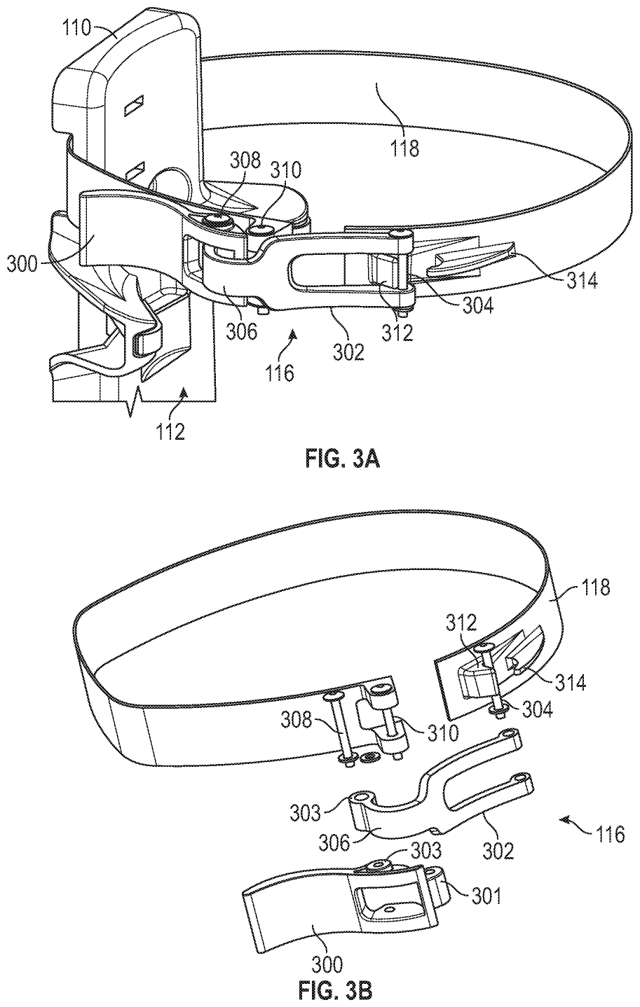

FIGS. 3A and 3B show detailed perspective views of components of the device mount 110. Referring first to FIG. 3A, one example of the latch belt 118 and latch 116 (collectively, the latch) are shown. The latch belt 118, in one example, extends from the device mount 110, For instance, one or more of deflectable fittings are configured to receive the latch belt 118 and hold the latch belt 118 to the device mount 110. As shown in FIG. 3A, the latch belt 118 extends from each side of the device mount 110. For instance, a longer end of the latch belt 118 extends from the portion of the device mount 110 into the page of FIG. 3A. The end of the latch belt 118 extends to the latch 116, for instance, to a belt hook 312 associated with one or more other components of the latch 116. The opposed end of the latch belt 118 extends along the device mount 110 (for instance along a rear surface) and is coupled with the remainder of the latch 116 including, for instance, an operator 300 and a buckle 302.

Referring now to FIG. 3B, the latch belt 118 and latch 116 are shown in an exploded view. The latch belt 118, as shown, is a discontinuous ring including an operator pivot 310 associated with an end of the latch belt 118 and a belt hook 312 associated with an opposed end of the latch belt 118. The operator pivot 310 is configured to couple with the operator 300, for instance, a pivot joint 301 of the operator 300 to facilitate rotation of the operator 300 relative to the latch belt 118. As described herein, rotation of the operator 300 relative to the operator pivot 310 at the pivot joint 301 moves the operator 300 as well as the associated buckle 302, between latched and unlatched positions.

A buckle 302 extends across the opposed ends of the latch belt 118 and provides an interface between the latch belt 118 ends to facilitate tightening of the latch belt 118 and secure grasping of the fire extinguisher 102 with the device mount 110. As shown, the buckle 302 includes a tongue 306 extending from the remainder of the buckle. As will be described and shown in FIG. 3A, the tongue 306 of the buckle 302 is rotatably coupled with a corresponding portion of the operator 300, for instance, with the buckle pivot 308 at a tongue pivot joint 303. The opposed end of the buckle 302 includes one or more forks (e.g., arms, members or the like) configured to receive and couple with the latch pin 304. The latch pin 304 is, in turn, selectively coupled with the belt hook 312 to initiate tightening of the latch belt 118.

As further shown in FIG. 3B, a shuttle 314 is proximate to the belt hook 312 and provides a tapered profile to facilitate passage of the belt hook 312, for instance, between the agent container 109 and the discharge hose 107 of the fire extinguisher 102 when the extinguisher is removed from the device mount 110 (e.g., during use). As described herein, the shuttle 314 prevents fouling, catching or the like of the latch belt 118 between the agent container and the discharge hose 107 that might otherwise frustrate rapid removal of the fire extinguisher 102 from the device mount 110.

Referring again to FIG. 3A, the latch belt 118, as previously described, is shown coupled with the support frame 112 of the device mount 110. In this example, the latch pin 304 of the buckle 302 is shown engaged with or received within the belt hook 312 of the opposed end of the latch belt 118. The buckle 302 spans across the ends of the latch belt 118 and is rotatably coupled at the buckle pivot 308 with the tongue pivot joint 303 associated with the operator 300 and the buckle 302. The opposed end of the operator 300 (relative to the buckle pivot 308) is coupled by way of an operator pivot 310 with the other end of the latch belt 118.

With reception of the latch pin 304 with the belt hook 312, the latch 116 is ready for tightening of the latch belt 118 around the fire extinguisher 102. With the fire extinguisher 102 coupled along the device mount 110 and the latch belt 118 extended around the agent container 109, the operator 300 (in a projecting configuration (extending at an angle relative to the orientation shown in FIG. 3A) is rotated toward the proximate portion of the latch belt 118 and the orientation shown in FIG. 3A. Rotation of the operator 300 draws the tongue 306 in a lateral fashion, for instance, from right to left thereby engaging the latch pin 304 within the belt hook 312. The operator 300 draws the tongue 306, the belt hook 312 and the corresponding portion of the latch belt 118 toward the opposed end of the latch belt 118. Continued movement of the operator 300 deflects one or more of the operator 300, the buckle 302 or the latch belt 118. The deflection of one or more of these components facilitates the movement of the operator 300 into the orientation shown in FIG. 3A. Additionally, the deflection moves the tongue 306 over-center, for instance, over top of the operator pivot 310 and affirmatively seats the latch pin 304 within the belt hook 312 and securely tightens the latch belt 118 around the fire extinguisher 102.

Optionally, the components of the latch belt 118 and the latch 116 are, in various examples, constructed with polymers including, but not limited to, nylon or other erosion resistant polymer materials. In another example, one or more components of the latch 116 are constructed with polymers or a metal, such as aluminum, having some degree of corrosion resistance. The metal operator 300, buckle 302 or the like are, in one example, the only components of the latch, including the latch belt 118, that are constructed with metal. Optionally, one or more of the latch pin 304, operator pivot 310 or buckle pivot 308 are constructed with metal to minimize deflection of these loadbearing components of the latch 116. By providing the latch belt 118 as a polymer, in one example, deflection of the latch belt 118 (e.g., stretching, elastic deformation or the like) is used to secure or enhance the securing of the latch belt 118 around the fire extinguisher 102,

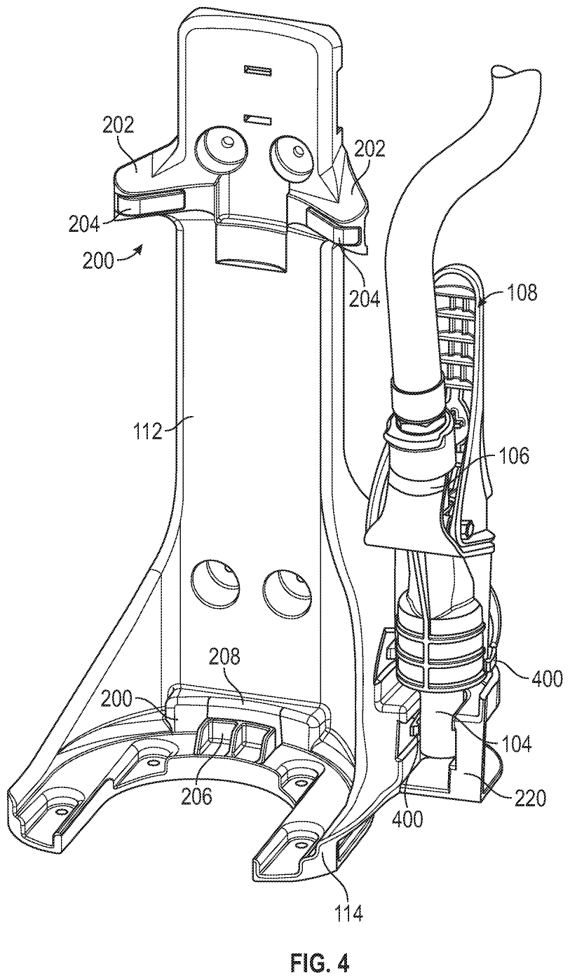

FIG. 4 is a detailed perspective view of a portion of the device mount 110 including the device brace 200. As shown in this example, the device brace 200 includes one or more brace arms 202 extending from the remainder of the support frame 112. Additionally, the device brace 200 includes an anchor cleat 206 sized and shaped to couple with or engage with one or more corresponding components of the fire extinguisher 102, such as a base flange. In one example, the anchor cleat 206 is opposed to or proximate to an anchor wall 208 formed as a component of the device socket 114 or the support frame 112. As will be described herein, the device brace 200 cooperatively engages the components of the brace with corresponding components of the fire extinguisher 102 to provide a multi-point engagement with the fire extinguisher 102. The latch 116 and latch belt 118 cooperate to drive the fire extinguisher 102 into engagement with these features and thereby robustly couple (e.g., secure, fix, hold, retain or the like) the fire extinguisher 102 in tight continuous engagement with the device mount 110 while at the same time minimizing (including eliminating) relative rotation, movement or the like there between.

Referring again to FIG. 4, the device mount 110, in this example, includes one or more brace arms 202. In this example, two brace arms 202 extend from either side of the support frame 112. In another example, a single brace arm 202 extends across the support frame 112 and accordingly provides a cup or horseshoe shaped surface extending from end to end of the brace arm. As further shown in FIG. 4, in this example the brace jaws 204 are included with the brace arms 202. The brace jaws 204 are constructed with or include polymer materials similar or identical to those of the brace arm 202 and the support frame 112. For instance, in one example, the support frame 112, brace arms 202 and device socket 114 are constructed with, but not limited to, a polymer such as nylon or the like. In another example, the brace jaws 204 include a different polymer than the remainder of the device mount 110 including, but not limited to, a rubber, silicone rubber, butyl rubber or the like.

As described herein, the brace jaws 204 deflect, in one example, in a similar manner to the brace arms 202 to accordingly conform to a profile of the fire extinguisher 102 and thereby securely hold the fire extinguisher 102 in place along the device mount 110. As additionally discussed herein, the anchor cleat 206, optionally in combination with the anchor wall 208, cooperates with operation of the brace jaws 204 and the brace arms 202 to enhance the multi-point engagement with the fire extinguisher 102 and thereby enhance securing of the fire extinguisher to the device mount 110.

As further shown in FIG. 4, the example device mount 110 includes the nozzle socket 220. As shown, the nozzle 104 is received within the nozzle socket 220. Optionally, the nozzle socket 220 includes one or more deflectable barbs, arms, members or the like configured to engage with corresponding components of the nozzle 104 including, but not limited to, the nozzle 104 itself and one or more of the discharge valve 106 or the valve operator 108. For instance, as shown in FIG. 4, one or more deflectable detents 400 including catches, hooks or the like are configured to engage with corresponding components of one or more of the nozzle 104 or the valve operator 108. The coupling of the deflectable detents 400 with the nozzle 104 and proximate components of the nozzle securely holds the nozzle 104 as well as the discharge hose 107 in place.

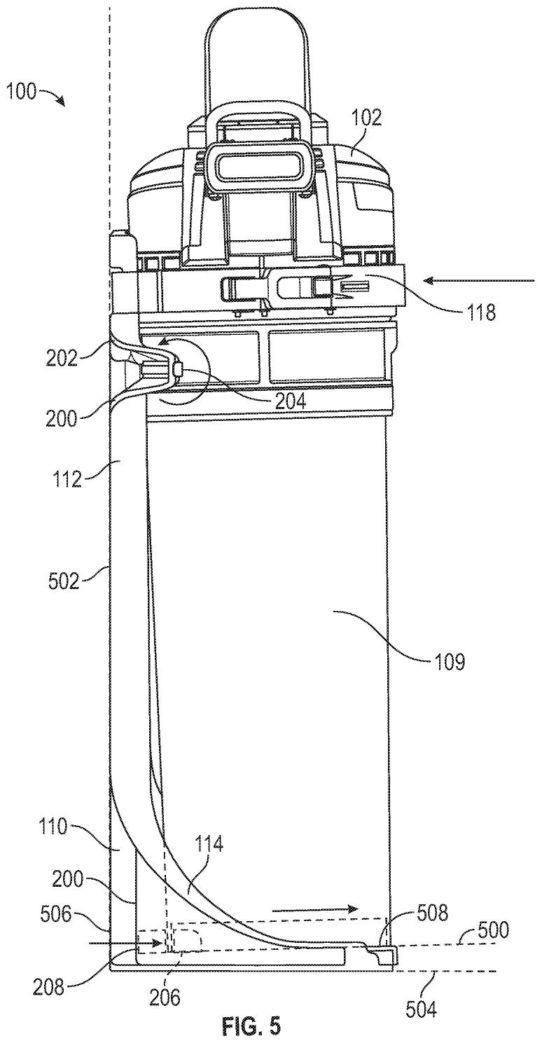

FIG. 5 shows a side view of the mounted fire extinguisher assembly 100 including the device mount 110 and the fire extinguisher 102 loaded within the device mount 110. As previously described, the fire extinguisher 102 is, in one example, coupled with the device mount 110 (e.g., with a latch belt 118), As shown in FIG. 5, the latch belt 118, in this example, is provided above or proximate to the brace arms 202 of the device brace 200. For instance, the latch belt 118 is provided proximately above the brace arms 202. Tightening of the latch belt 118 (e.g., with the latch 116) moves the agent container 109 snugly against the support frame 112 and into the device socket 114 of the device mount 110. As previously described, the latch belt 118 tightens, with rotation of the latch 116, around the fire extinguisher 102 and drives the fire extinguisher 102 toward the support frame 112. Movement of the agent container 109 drives the extinguisher 102 into engagement with the brace arms 202 and deforms or deflects the brace arms 202 as shown herein. Additionally, the brace arms 202 include brace jaws 204 including, for instance, silicone rubber fittings or the like that are similarly deformed by driving of the fire extinguisher 102 into engagement with the brace arms 202 of the device brace 200.

As further shown in FIG. 5, the agent container 109 of the fire extinguisher 102 includes a container base flange 508. As shown in FIG. 5, the container base flange 508 is an annular flange extending along a lower portion of the agent container 109. A portion of the container base flange 518 is received between the anchor cleat 206 and the anchor wall 208 of the device brace 200 as part of the device mount 110. Reception of the container base flange 508 between the anchor cleat 206 and the anchor wall 208 secures the lower portion of the agent container 109 within the device mount 110 and provides another point of engagement between the fire extinguisher 102 and the device mount 110 in addition to the one or more points of engagement provided by the brace arms 202.

As shown in FIG. 5, the latch belt 118 is coupled at a proximate location relative to the brace arms 202. In this example, the latch belt 118 is provided above the brace arms 202. Accordingly, tightening of the latch belt 118 biases the fire extinguisher 102 from the right toward the left and the device mount 110 and accordingly drives the fire extinguisher 102 into engagement with the brace arms 202. As shown in FIG. 5, movement of the fire extinguisher 102 moves the upper portion of the fire extinguisher 102 from the right to the left as shown with the upper right to left arrow. A moment is generated around the brace arms 202 by this movement. For instance, the brace arms 202 serve as a fulcrum or pivot point for the fire extinguisher 102. The opposed portion of the fire extinguisher 102 corresponding to the lower portion of the agent container 109, such as the container base flange 508, moves in a converse direction according to the moment provided around the brace arms 202. As shown with the lower arrows provided in FIG. 5, the container base flange 508 is biased outwardly by rotation at the brace arms 202 to affirmatively engage the container base flange 508 with the anchor cleat 206. Accordingly, by tightening the latch belt 118 around the fire extinguisher 102, the device mount 110 provides affirmative multi-point engagement with the fire extinguisher 102 at a plurality of locations including at the brace arms 202 as well as at the anchor cleat 206. The fire extinguisher 102 is thereby held immobile relative to the device mount 110 to substantially prevent relative motion therebetween and accordingly secure the fire extinguisher 102.

As further shown in FIG. 5, the device mount 110, in one example, includes a tapered or angled profile configured to position the fire extinguisher 102 in a leaning configuration (e.g., tipped or angled toward to the support frame 112) relative to the device mount 110. For instance, as shown in FIG. 5, the device socket 114 includes a reclined grade 500 relative to horizontal 504. The reclined grade 500 orients the fire extinguisher 102 positioned on the device mount 110 in a leaning configuration relative to vertical 506. For instance, as shown, the fire extinguisher 102 is at a slight angle relative to vertical 506 and leans toward the frame interface 502 of the support frame 112. In the configuration shown in FIG. 5, the fire extinguisher 102 is held in a leaning configuration relative to the support frame 112 to ensure the fire extinguisher 102 remains on the device mount 110, for instance, when the latch belt 118 is decoupled through opening of the latch 116, and prior to manual removal by an operator.

In operation, the reclined grade 500 (e.g., a half degree to one and a half degrees or more) relative to horizontal 504 leans or tips the fire extinguisher 102 back into the device mount 110. Accordingly, as the fire extinguisher 102 is positioned in the device mount 110, the device socket 114 readily couples with the container base flange 508 and retains the fire extinguisher 102 along the device mount 110 to facilitate coupling of the latch belt 118 to facilitate affirmative engagement or securing of the fire extinguisher 102 within the mount 110. Similarly, when decoupling of the fire extinguisher 102 is desired, for instance, during use, operation of the latch 116 to open the latch belt 118 releases the fire extinguisher 102 from affirmative engagement with the device mount 110 (e.g., the multi-point engagement with the device brace 200). In this released configuration, the reclined grade 500 of the device socket 114 retains the fire extinguisher 102 within the device mount 110 upon release of the latch belt 118. Accordingly, to remove the fire extinguisher 102 from the device mount 110 after release of the latch belt 118, the operator manually grasps the fire extinguisher 102 and rotates or pulls it from the device mount 110. Dropping or tipping of the fire extinguisher 102 from the device mount 110 is thereby substantially minimized.

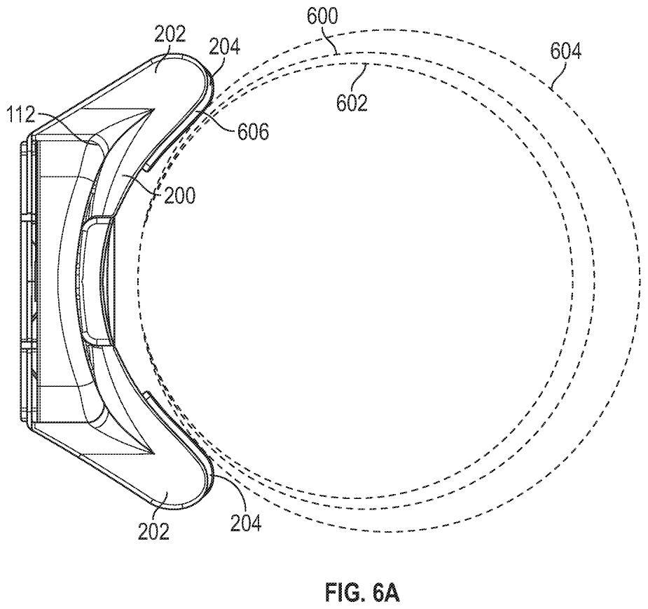

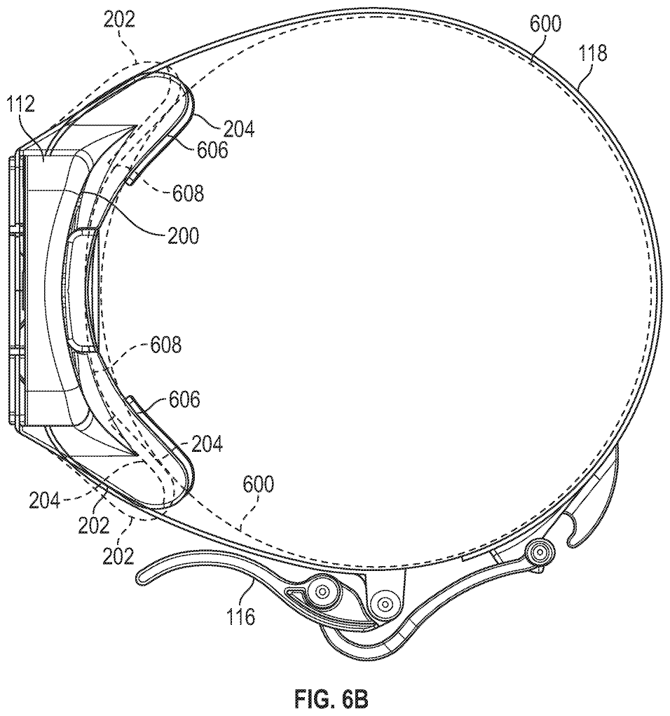

FIG. 6A shows another example of a portion of the device mount 110 including the support frame 112. As further shown in FIG. 6A, a plurality of fire extinguishers and their corresponding extinguisher profiles 600, 602, 604 are shown in proximate positions relative to the support frame 112 and the brace arms 202. As shown, the one or more brace arms 202, including the respective brace jaws 204, are in an initial profile 606 relative to a deflected or deformed profile shown in FIG. 6B. As shown, each of the fire extinguisher profiles 600, 602, 604 correspond to different sized (or shaped) fire extinguishers that are configured to fit with and be secured along the support frame 112 of the device mount 110.

Referring again to FIG. 6A, as previously described, the support frame 112 including the device brace 200 is shown in the initial profile 606. The brace jaws 204 of the opposed brace arms 202 are shown in proximate position relative to each of the fire extinguisher profiles 600, 602, 604. Each of the fire extinguisher profiles 600-604 vary in size and optionally shape. For instance, the fire extinguisher profile 602 has the smallest profile of the extinguishers while the fire extinguisher profile 604 is largest. Each of these fire extinguisher profiles 600-604 are positioned, as shown in FIG. 6A, proximate to the brace jaws 204 and the brace arms 202 of the device brace 600. The fire extinguisher profile 600, 602, 604 are shown in position prior to tightening or fastening of the fire extinguishers to the device mount 110.

FIG. 6B shows one example of the fire extinguisher profiles, the profile 600 (shown in FIG. 6A) in a grasping configuration with the device mount 110. As shown in FIG. 6B, the latch belt 118 extends around the fire extinguisher profile 600 and the latch 116 tightens the latch belt 118 around the fire extinguisher profile 600 and drives the fire extinguisher toward the support frame 112 and the brace arms 202.

With the latch belt 118 tightened around the fire extinguisher profile 600, the brace arms 202 are deflected into a conforming profile 608 shown in dashed lines in FIG. 6B. The initial profile 606 of the brace arms 202 is shown in solid lines in FIG. 6B to provide a comparison to the conforming profile 608 including the deflected brace arms. The tightening of the latch belt 118 moves the fire extinguisher into close and intimate engagement with the one or more brace arms 202 and the associated brace jaws 204. Tightening of the latch belt 118 deflects the brace arms 202 and the associated brace jaws 204 to provide an intimate multi-point secure engagement between the brace arms 202 and the fire extinguisher profile 600. Accordingly, as shown in FIG. 6B, the deflection of the brace arms 202 conforms the brace arms to the fire extinguisher profile 600 shown. In a similar manner, for instance, with the fire extinguisher profiles 602, 604 (respectively smaller and larger than the fire extinguisher profile 600) operation of the latch belt 118 deforms the brace arms 202 of the device brace 200 into a corresponding profile (e.g., the conforming profile 608) relative to the profiles 600, 602, 604 of the respective extinguishers. With engagement and deflection of the brace arms 202, the brace jaws 204 as part of the brace arms 202 are similarly deflected. For instance, where the brace jaws 204 include a deformable material such as silicone rubber, butyl rubber or the like, the brace jaws 204 deflect and provide a secure frictional engagement between the fire extinguisher profile 600 and the support frame 112 of the device mount 110.

Upon release, for instance operation of the latch 116 to loosen the latch belt 118, the fire extinguisher 600 is optionally biased away from the support frame 112 as the brace arms 202 resume their previous initial profile 606. For instance, the elastomeric character of the support frame 112 of the device mount 112 (e.g., a polymer) biases the brace arms 202 into the initial profile 606 after loosening of the latch belt 118. Decoupling of the latch 116 from an end of the latch belt 118 frees the fire extinguisher 102 from the device mount 110 and facilitates decoupling from the support frame 112. Conversely, installation of the fire extinguisher to the device mount, for instance, along the support frame 112 positions the fire extinguisher profile 600 (or 602, 604 or the like) proximate to the brace arms 202. Tightening of the latch belt 118 drives the fire extinguisher profile 600 into the brace arms 202 and deflects the brace arms and associated brace jaws 202, 204 into the conforming profile 608 that grasps the fire extinguisher profile 600 in one or more locations.

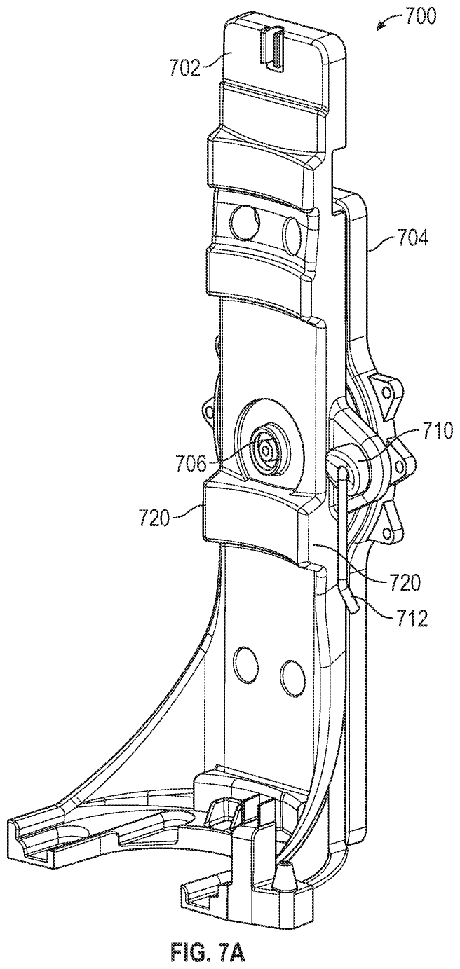

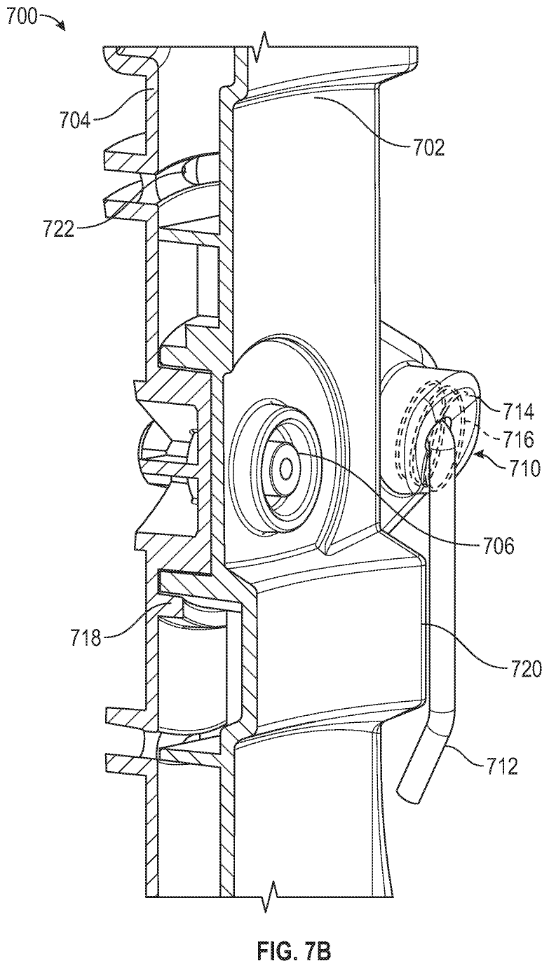

FIGS. 7A and 7B show another example of a device mount 700. In this example, the device mount 700 includes one or more pivotable or rotatable features to facilitate service of a fire extinguisher, such as the fire extinguisher 102 mounted with the device mount 700. Referring first to FIG. 7A, the device mount 700 includes a service base 704 configured for coupling with one or more surfaces such as a wall, bulkhead or the like. A service carriage 702 is rotatably coupled with the service base 704 with a pivot joint 706. In one example, the service carriage 702 rotates relative to the service base 704 around the pivot joint 706 to provide access to one or more portions of the fire extinguisher mounted to the device mount 700 without requiring decoupling of the fire extinguisher from the device mount 700.

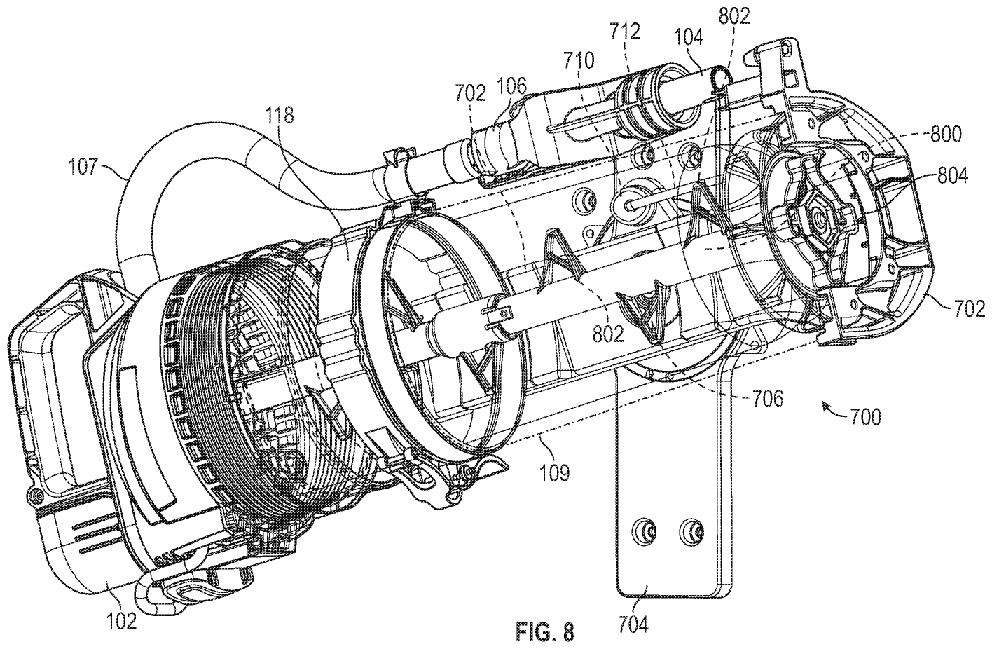

As further shown in FIG. 7A, a carriage lock 710 is, in one example, coupled between the service carriage 702 and the service base 704 to accordingly hold or retain the service carriage 702 in the configuration shown in FIG. 7A (e.g., a stowed orientation). As shown in FIG. 7A, the carriage lock 710, in one example, includes a lock operator 712 for manual operation by an operator, service technician or the like. The lock operator 712 is operated to unlatch the service carriage 702 from the service base 704 and allow rotation of the service carriage 702 and the fire extinguisher thereon relative to the service base 704. As will be described herein, the carriage lock 710, in one example, includes one or more pins, detents or the like configured to retain the service carriage 702 in a service orientation (shown in FIG. 8).

In another example, the device mount 700, including the pivot joint 706 and the rotatable service carriage 702, includes one or more pivot stops 720 configured to arrest rotation of the service carriage 702 and accordingly prevent spinning rotation of the service carriage and associated fire extinguisher relative to the service base 704 (for instance, beyond a specified degree measure, relative to vertical or the like). The pivot stop 720, in this example, includes components or portions of the service carriage 702 configured to engage with a corresponding pivot rail, such as the pivot rail 718, shown in FIG. 7B. As the service carriage 702 is rotated into one or more service positions, the pivot stops 720 engage against the pivot rail 718 including, for instance, portions of the pivot rail, such as its ends, to arrest further rotation of the service carriage 702 beyond a specified angle.

FIG. 7B shows one example of a pivot rail 718 provided with the service base 704. As shown, the pivot rail 718, in this example, has an arcuate configuration extending into and out of the page. The pivot stops 720 are associated with the service carriage 702. Rotation of the service carriage 702 accordingly moves the pivot stops 720 into a proximate position relative to the pivot rail 718. Further rotation of the carriage 702 around the pivot joint 706 engages the pivot stops 720 with the pivot rail 718 and arrests further rotation.

As further shown in FIG. 7B, the carriage lock 710 is coupled between the service base 704 and the service carriage 702. For instance, the carriage lock 710 includes a lock operator 712 that is operable to release the carriage lock 710 and permit rotation of the service carriage 702 (and a mounted fire extinguisher) relative to the service base 704. In one example, the lock operator 712 is manually operable by rotation or pulling of the lock operator. As shown in FIG. 7B, the lock operator 712 extends into the carriage lock 710, for instance, into an operator cam 714. The end of the lock operator 712 projects through the operator cam 714 and is received within a locking port (or ports) 722 formed along the service base 704 and shown in FIG. 7B, for instance in a groove, track or the like.

In one example, with the service carriage 702 in the stowed orientation, the carriage lock 710 (e.g., the end of the lock operator 712) is positioned in a corresponding locking port 722 to fix the service carriage 702 in place relative to the service base 704. To rotate the service carriage 702 and the secured fire extinguisher into the service orientation the carriage lock 710 is released. For instance, the lock operator 712 is rotated, for instance, with the lock operator 712 sliding along the operator cam 714 to bias the lock operator 712 outwardly decouple from the locking port 722. In one example, a biasing element 716, such as a coil or torsional spring, is provided with the carriage lock 710 to bias the lock operator 712 to the locked orientation shown in FIG. 7B lock the service carriage 702 automatically in a position such as the stowed orientation, service orientation or the like described herein (e.g., with the lock operator 712 received in a corresponding locking port 722). Release of the lock operator 712 allows for rotation of the service carriage 702 as described herein, and the biasing element 716 biases the lock operator 712 toward the service base 704. Upon release of the lock operator 712 by a user the lock operator 712 follows the contour of the operator cam 714 and automatically rotates to the position shown in FIG. 7B. The operator cam 714 correspondingly guides movement of the lock operator 712 to the locking position shown in FIG. 7B.

FIG. 8 shows one example of the fire extinguisher 102 in a service orientation. For instance, the service carriage 702 secures the fire extinguisher 102 in a manner as previously described herein including, for instance, a device brace 200 including one or more brace arms 202, an anchor cleat 206 or the like. In the view shown in FIG. 8, the service carriage 702, as shown in solid lines behind the dashed line portions of the fire extinguisher 102, is rotated into the service orientation, for instance, to stir, fluff, agitate or conduct other service on the fire suppression agent or the fire extinguisher 102 itself. In this example, the agent container 102 and the service carriage 702 are rotated approximately 135 degrees relative to the stowed orientation shown in FIGS. 7A, B.

In operation, the carriage lock 710 is released while the service carriage 702 is in the stowed orientation to release the service carriage 702 from the service base 704 and permit rotation around the pivot joint 706. The operator or service technician rotates the fire extinguisher 102 and the service carriage 702 secured to the fire extinguisher, as shown in FIG. 8. As the fire extinguisher 102 and the service carriage 702 are rotated, the carriage lock 710, for instance an end of the lock operator 712, travels along the service base 704 and is biased (e.g., by the biasing element 716) into one or more of the locking ports 722 to hold the service carriage 702 in the service orientation shown in FIG. 8.

In the service orientation, the fire extinguisher 102 is ready for servicing while mounted to the device mount 700. For instance, an agitation operator 804 is shown exposed or revealed through the device socket of the service carriage 702. In one example, the agitation operator 804 includes a knob, dial or the like configured to operate an agent agitator 800 including one or more agitator baffles 802. In the stirring or service orientation shown in FIG. 8, the fire suppression agent within the agent container 109 is biased in a direction converse to a direction of settling, for instance, aligned with vertical. Accordingly, rotation of the agent agitator 800 by the agitation operator 804 engages the agitator baffles 802 against settled fire suppression agent and breaks up the settled fire suppression agent and facilitates its fluffing, stirring or agitating and disburses the stirred fire suppression agent throughout the agent container 109.

After operation of the agent agitator 800, in one example, the carriage lock 710 is operated again, for instance, to move the lock operator 712 out of one or more of the locking ports 722 and free the service carriage 702 for rotation relative to the service base 704. The service carriage 702, as well as the fire extinguisher 102 secured to the service carriage 702 are rotated back to the stowed orientation shown, for instance, in FIGS. 7A, 7B. The carriage lock 710 is then reset, for instance an end of the lock operator 712 received in a corresponding locking port 722 associated with the stowed orientation. The lock operator 712 fixes the service carriage 702 in the stowed orientation relative to the service base 704. Accordingly, after service, the fire extinguisher 102 remains mounted with the device mount 700 and, when in the stowed orientation 702, is securely held in a secure configuration that anchors the fire extinguisher 102 to a surface coupled with the device mount 700.

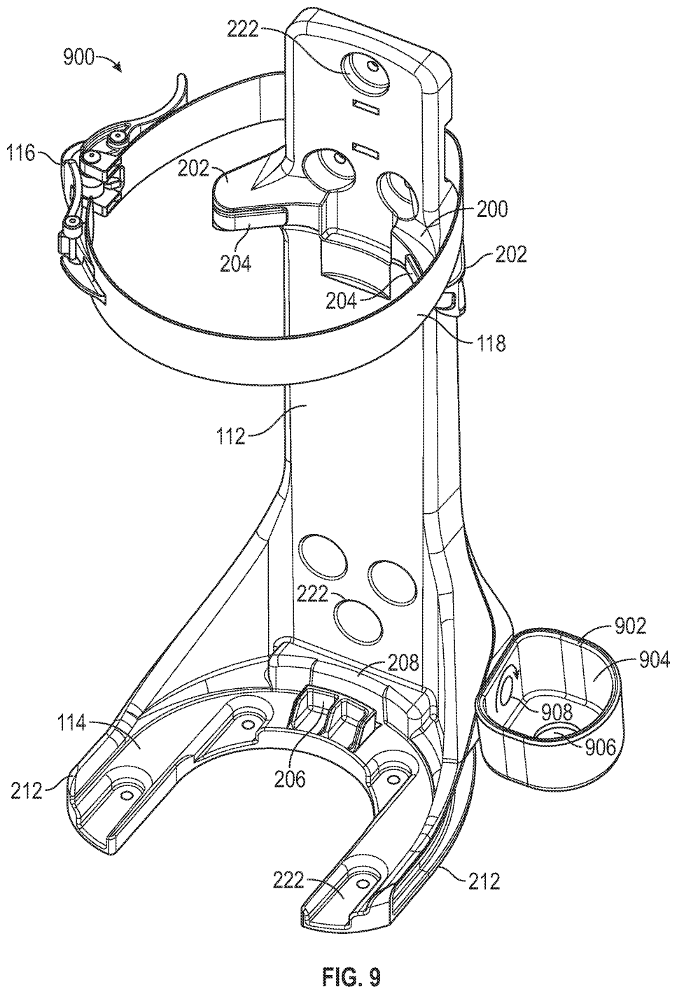

FIG. 9 is a perspective view of another example of a device mount 900 including a configurable nozzle socket 902. The device mount 900 is similar in some regards to the device mount 110 previously described herein, and shown for example in FIG. 4. The device mount 900 includes a support frame 112 and a device socket 114 configured to couple with a fire extinguisher, and hold the fire extinguisher in a secure manner. As shown in FIG. 9, the device mount 900 includes a device brace 200 having the brace arms 202 and the anchor cleat 206 configured to retain the fire extinguisher securely to the mount 900 through cooperation with the fastened latch belt 118.

In one example, the device mount 900 includes a plurality of mounting ports 222 at one or more locations of the mount including, but not limited to, the support frame 112, the device socket 114 (e.g., the socket legs 212) or the like. In the example shown in FIG. 9 additional mounting ports 222 are provided along the support frame 112 to facilitate installation of the mount 900 for one or more different types of service. For instance, when mounted to a stud (e.g., wooden or steel stud) the mounting ports 222 provided at the upper most and lower most locations on the support frame 112 are used for installation. In a dynamic environment, for instance on board a vehicle such as a truck or the like, multiple mounting ports 222 are used including, but not limited to each of the mounting ports 222 provided along the right and left edges of the support frame 112. In a heavy, dynamic environment installation, such as onboard a seagoing vessel, each of the mounting ports 222 are optionally used for mounting (e.g., to a bulkhead), including each of the ports 222 along the right and left edges and at least the upper most mounting port 222.

Referring again to FIG. 9, one example of a configurable nozzle socket 902 is shown. The nozzle socket 902 is coupled with the remainder of the device mount 900, for instance with a socket pivot 908. The nozzle socket 902 is rotatable relative to the device mount 900 at the socket pivot 908. As further shown in FIG. 9, the nozzle socket 902 includes one or more nozzle ports, such as a first nozzle port 904 and a second nozzle port 906. The first nozzle port 904 has a larger profile than the second nozzle port 906 and is thereby configured for reception of correspondingly larger nozzles, such as the nozzle 104 shown in FIG. 1. The second nozzle port 906 is smaller and configured for reception of a smaller nozzle, for instance the lower (and smaller) portion of the nozzle 104 shown in FIG. 4.

In operation, the device mount 900 is installed (e.g., fastened through the mounting ports 222), The nozzle socket 902 is configured based on the nozzle profile of the fire extinguisher retained in the mount 900. The installer rotates the nozzle socket 902 to orient either of the first or second nozzle ports 904, 906 for reception of the corresponding nozzle therein. Optionally, the socket pivot 908 includes a friction fit, detent or the like configured to retain the nozzle socket 902 in the specified orientation. If the device mount 900 is later used with a different fire extinguisher, for instance having a different (larger or smaller) nozzle, the nozzle socket 902 is reoriented to accommodate the different nozzle style.

### Various Notes and Aspects

Aspect 1 can include subject matter such as a fire extinguisher device mount comprising: a support frame configured for coupling along a fire extinguisher device received in the device mount, the support frame includes: a first brace arm having a first brace jaw; a second brace arm having a second brace jaw; and a device socket having an anchor cleat; a latch belt having a latch, the latch belt extends from the support frame and is configured to releasably surround the fire extinguisher device; and a device brace configured to secure the fire extinguisher device in a grasping configuration, the device brace in the grasping configuration includes: the latch belt tightened around the fire extinguisher device; the first and second brace arms deflected with engagement of the first and second brace jaws against the fire extinguisher device; and the anchor cleat engaged against the fire extinguisher device.

Aspect 2 can include, or can optionally be combined with the subject matter of Aspect 1, to optionally include wherein the support frame and the latch belt include a molded polymer.

Aspect 3 can include, or can optionally be combined with the subject matter of one or any combination of Aspects 1 or 2 to optionally include wherein one or more of the support frame or the latch belt include a polyamide.

Aspect 4 can include, or can optionally be combined with the subject matter of one or any combination of Aspects 1-3 to optionally include wherein the first and second brace arms are configured to deflect in the grasping configuration relative to a released configuration having the latch belt loose.

Aspect 5 can include, or can optionally be combined with the subject matter of one or any combination of Aspects 1-4 to optionally include wherein in the grasping configuration the latch belt tightened around the fire extinguisher device drives the first and second brace jaws into engagement against the fire extinguisher device and deflects the first and second brace arms.

Aspect 6 can include, or can optionally be combined with the subject matter of Aspects 1-5 to optionally include wherein in the grasping configuration the deflected first and second brace arms conform to a container profile of the fire extinguisher device.

Aspect 7 can include, or can optionally be combined with the subject matter of Aspects 1-6 to optionally include wherein in the grasping configuration the anchor cleat engaged against the fire extinguisher device includes the anchor cleat seated against the fire extinguisher device.

Aspect 8 can include, or can optionally be combined with the subject matter of Aspects 1-7 to optionally include wherein the device socket includes an anchor wall, and in the grasping configuration the anchor cleat and the anchor wall capture a portion of the fire extinguisher device between the anchor cleat and the anchor wall.

Aspect 9 can include, or can optionally be combined with the subject matter of Aspects 1-8 to optionally include a nozzle socket coupled with the support frame, the nozzle socket is configured to secure a hose nozzle of the fire extinguisher device.

Aspect 10 can include, or can optionally be combined with the subject matter of Aspects 1-9 to optionally include wherein the support frame includes: a service base configured for coupling with a surface; a service carriage having the device brace, and the service carriage is rotatably coupled with the service base at a pivot joint.

Aspect 11 can include, or can optionally be combined with the subject matter of Aspects 1-10 to optionally include wherein the support frame includes a carriage lock configured to lock the service carriage in one or more orientations relative to the service base.

Aspect 12 can include, or can optionally be combined with the subject matter of Aspects 1-11 to optionally include the fire extinguisher device.

Aspect 13 can include, or can optionally be combined with the subject matter of Aspects 1-12 to optionally include a mounted fire extinguisher assembly comprising: a support frame having a device brace, the device brace includes: at least one brace arm having a brace jaw; and an anchor cleat; a latch belt having a latch, the latch belt extends from the support frame; at least one fire extinguisher device of a plurality of fire extinguisher devices coupled with the support frame in a grasping configuration, each of the fire extinguisher devices of the plurality of fire extinguisher devices includes: an agent container having a container profile, and wherein the container profiles of each of the plurality of fire extinguisher devices are different; and wherein the device brace is configured to secure each of the plurality of fire extinguisher devices in the grasping configuration including: the latch belt tightened around the container profile of the at least one tire extinguisher device; the at least one brace arm deflected with engagement of the brace jaw against the container profile of the at least one fire extinguisher device; and the anchor cleat engaged against the agent container.

Aspect 14 can include, or can optionally be combined with the subject matter of Aspects 1-13 to optionally include wherein the at least one fire extinguisher device of the plurality of fire extinguisher devices includes a first fire extinguisher device having a first container profile for a first agent container and a second fire extinguisher device having a second container profile for a second agent container different than the first container profile, and the device brace is configured to secure each of the first and second fire extinguisher devices in the grasping configuration.

Aspect 15 can include, or can optionally be combined with the subject matter of Aspects 1-14 to optionally include wherein in the grasping configuration the latch belt is tightened around either of the first or second container profiles, the at least one brace arm is deflected with engagement against the first or second container profiles, and the anchor cleat is engaged against the first or second agent containers.

Aspect 16 can include, or can optionally be combined with the subject matter of Aspects 145 to optionally include wherein the support frame and the latch belt include a molded polymer.

Aspect 17 can include, or can optionally be combined with the subject matter of Aspects 1-16 to optionally include wherein at least one brace arm includes first and second brace arms having respective first and second brace jaws.

Aspect 18 can include, or can optionally be combined with the subject matter of Aspects 1-17 to optionally include wherein in the grasping configuration the latch belt tightened around the at least one fire extinguisher device drives the brace jaw into engagement against the container profile and deflects the at least one brace arm.

Aspect 19 can include, or can optionally be combined with the subject matter of Aspects 1-18 to optionally include wherein in the grasping configuration the deflected at least one brace arm conforms to the container profile of the at least one fire extinguisher device.

Aspect 20 can include, or can optionally be combined with the subject matter of Aspects 1-19 to optionally include a nozzle socket coupled with the support frame, the nozzle socket is configured to secure a hose nozzle of the fire extinguisher device.

Aspect 21 can include, or can optionally be combined with the subject matter of Aspects 1-20 to optionally include a method for mounting a fire extinguisher device comprising: engaging an anchor cleat of a device mount against the fire extinguisher device; moving the fire extinguisher device toward at least one brace arm having a brace jaw of the device mount; and grasping the fire extinguisher device with a device brace of the device mount, grasping the fire extinguisher device includes: tightening a latch belt around a container profile of the fire extinguisher device; engaging the brace jaw of the at least one brace arm against the container profile; deflecting the at least one brace arm based on tightening of the latch belt, the deflected at least one brace arm conforms to the container profile.

Aspect 22 can include, or can optionally be combined with the subject matter of Aspects 1-21 to optionally include wherein engaging the anchor cleat includes capturing a portion of the fire extinguisher between the anchor cleat and an anchor wall of the device mount.

Aspect 23 can include, or can optionally be combined with the subject matter of Aspects 1-22 to optionally include wherein tightening the latch belt around the container profile includes: pulling a buckle over an operator pivot with an operator; engaging a latch pin of the buckle against a belt hook of the latch belt based on pulling of the buckle; deflecting one or more of the buckle or the operator; and retaining the latch pin against the belt hook based on the deflection of one or more of the buckle or the operator.

Aspect 24 can include, or can optionally be combined with the subject matter of Aspects 1-23 to optionally include wherein engaging the brace jaw of the at least one brace arm against the container profile includes driving the container profile into the brace jaw of the at least one brace arm with tightening of the latch belt.

Aspect 25 can include, or can optionally be combined with the subject matter of Aspects 1-24 to optionally include wherein deflecting the at least one brace arm includes driving the container profile toward the at least one brace arm with tightening of the latch belt.

Aspect 26 can include, or can optionally be combined with the subject matter of Aspects 1-25 to optionally include wherein the fire extinguisher having the container profile includes a plurality of fire extinguishers having a plurality of different container profiles; and deflecting the at least one brace arm based on tightening of the latch belt includes deflecting the at least one brace arm into a plurality of different conforming arm profiles corresponding to the respective plurality of different container profiles.

Each of these non-limiting aspects can stand on its own, or can be combined in various permutations or combinations with one or more of the other aspects.

The above description includes references to the accompanying drawings, which form a part of the detailed description. The drawings show, by way of illustration, specific embodiments in which the invention can be practiced. These embodiments are also referred to herein as “aspects” or “examples.” Such aspects or example can include elements in addition to those shown or described. However, the present inventors also contemplate aspects or examples in which only those elements shown or described are provided. Moreover, the present inventors also contemplate aspects or examples using any combination or permutation of those elements shown or described (or one or more features thereof), either with respect to a particular aspects or examples (or one or more features thereof), or with respect to other Aspects (or one or more features thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Geometric terms, such as “parallel”, “perpendicular”, “round”, or “square”, are not intended to require absolute mathematical precision, unless the context indicates otherwise. Instead, such geometric terms allow for variations due to manufacturing or equivalent functions. For example, if an element is described as “round” or “generally round,” a component that is not precisely circular (e.g., one that is slightly oblong or is a many-sided polygon) is still encompassed by this description.

The above description is intended to be illustrative, and not restrictive. For example, the above-described aspects or examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as aspects, examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The claimed invention is:

1. A fire extinguisher device mount comprising:
a support frame configured for coupling along a fire extinguisher device received in the device mount, the support frame includes:
a first brace arm having a first brace jaw;
a second brace arm having a second brace jaw; and
a device socket having an anchor cleat;
a latch belt having a latch, the latch belt extends from the support frame and is configured to releasably surround the fire extinguisher device; and
a device brace configured to secure the fire extinguisher device in a grasping configuration, the device brace in the grasping configuration includes:
the latch belt tightened around the fire extinguisher device;
the first and second brace arms deflected with engagement of the first and second brace jaws against the fire extinguisher device; and
the anchor cleat engaged against the fire extinguisher device.

2. The fire extinguisher device mount of claim 1, wherein the support frame and the latch belt include a molded polymer.

3. The fire extinguisher device mount of claim 1, wherein one or more of the support frame or the latch belt include a polyamide.

4. The fire extinguisher device mount of claim 1, wherein the first and second brace arms are configured to deflect in the grasping configuration relative to a released configuration having the latch belt loose.

5. The fire extinguisher device mount of claim 1, wherein in the grasping configuration the latch belt tightened around the fire extinguisher device drives the first and second brace jaws into engagement against the fire extinguisher device and deflects the first and second brace arms.

6. The fire extinguisher device mount of claim 1, wherein in the grasping configuration the deflected first and second brace arms conform to a container profile of the fire extinguisher device.

7. The fire extinguisher device mount of claim 1, wherein in the grasping configuration the anchor cleat engaged against the fire extinguisher device includes the anchor cleat seated against the fire extinguisher device.

8. The fire extinguisher device mount of claim 1, wherein the device socket includes an anchor wall, and in the grasping configuration the anchor cleat and the anchor wall capture a portion of the fire extinguisher device between the anchor cleat and the anchor wall.

9. The fire extinguisher device mount of claim 1 comprising a nozzle socket coupled with the support frame, the nozzle socket is configured to secure a hose nozzle of the fire extinguisher device.

10. The fire extinguisher device mount of claim 1, wherein the support frame includes:
a service base configured for coupling with a surface;
a service carriage having the device brace, and the service carriage is rotatably coupled with the service base at a pivot joint.

11. The fire extinguisher device mount of claim 10 wherein the support frame includes a carriage lock configured to lock the service carriage in one or more orientations relative to the service base.

12. The fire extinguisher device mount of claim 1 comprising the fire extinguisher device.

13. A mounted fire extinguisher assembly comprising:
a support frame having a device brace, the device brace includes:
at least one brace arm having a brace jaw; and
an anchor cleat;
a latch belt having a latch, the latch belt extends from the support frame;
at least one fire extinguisher device of a plurality of fire extinguisher devices coupled with the support frame in a grasping configuration, each of the fire extinguisher devices of the plurality of fire extinguisher devices includes:
an agent container having a container profile, and wherein the container profiles of each of the plurality of fire extinguisher devices are different; and
wherein the device brace is configured to secure each of the plurality of fire extinguisher devices in the grasping configuration including:
the latch belt tightened around the container profile of the at least one fire extinguisher device;
the at least one brace arm deflected with engagement of the brace jaw against the container profile of the at least one fire extinguisher device; and
the anchor cleat engaged against the agent container.

14. The mounted fire extinguisher assembly of claim 13, wherein the at least one fire extinguisher device of the plurality of fire extinguisher devices includes a first fire extinguisher device having a first container profile for a first agent container and a second fire extinguisher device having a second container profile for a second agent container different than the first container profile, and the device brace is configured to secure each of the first and second fire extinguisher devices in the grasping configuration.

15. The mounted fire extinguisher assembly of claim 14, wherein in the grasping configuration the latch belt is tightened around either of the first or second container profiles, the at least one brace arm is deflected with engagement against the first or second container profiles, and the anchor cleat is engaged against the first or second agent containers.

16. The mounted fire extinguisher assembly of claim 13, wherein the support frame and the latch belt include a molded polymer.

17. The mounted fire extinguisher assembly of claim 13, wherein at least one brace arm includes first and second brace arms having respective first and second brace jaws.

18. The mounted fire extinguisher assembly of claim 13, wherein in the grasping configuration the latch belt tightened around the at least one fire extinguisher device drives the brace jaw into engagement against the container profile and deflects the at least one brace arm.

19. The mounted fire extinguisher assembly of claim 13, wherein in the grasping configuration the deflected at least one brace arm conforms to the container profile of the at least one fire extinguisher device.

20. The mounted fire extinguisher assembly of claim 13 comprising a nozzle socket coupled with the support frame, the nozzle socket is configured to secure a hose nozzle of the fire extinguisher device.

21. A method for mounting a fire extinguisher device comprising:
engaging an anchor cleat of a device mount against the fire extinguisher device;
moving the fire extinguisher device toward at least one brace arm having a brace jaw of the device mount; and
grasping the fire extinguisher device with a device brace of the device mount, grasping the fire extinguisher device includes:
tightening a latch belt around a container profile of the fire extinguisher device;
engaging the brace jaw of the at least one brace arm against the container profile;
deflecting the at least one brace arm based on tightening of the latch belt, the deflected at least one brace arm conforms to the container profile.

22. The method of claim 21, wherein engaging the anchor cleat includes capturing a portion of the fire extinguisher between the anchor cleat and an anchor wall of the device mount.

23. The method of claim 21, wherein tightening the latch belt around the container profile includes:
pulling a buckle over an operator pivot with an operator;
engaging a latch pin of the buckle against a belt hook of the latch belt based on pulling of the buckle;
deflecting one or more of the buckle or the operator; and
retaining the latch pin against the belt hook based on the deflection of one or more of the buckle or the operator.

24. The method of claim 21, wherein engaging the brace jaw of the at least one brace arm against the container profile includes driving the container profile into the brace jaw of the at least one brace arm with tightening of the latch belt.

25. The method of claim 24, wherein deflecting the at least one brace arm includes driving the container profile toward the at least one brace arm with tightening of the latch belt.

26. The method of claim 21, wherein the fire extinguisher having the container profile includes a plurality of fire extinguishers having a plurality of different container profiles; and
deflecting the at least one brace arm based on tightening of the latch belt includes deflecting the at least one brace arm into a plurality of different conforming arm profiles corresponding to the respective plurality of different container profiles.
